(19) United States
(12) Patent Application Publication
(10) Pub. No.: US 2015/0120623 A1
(43) Pub. Date: Apr. 30, 2015

(54) Method of Analyzing a Graph With a Covariance-Based Clustering Algorithm Using a Modified Laplacian Pseudo-Inverse Matrix

(71) Applicant: Battelle Memorial Institute, Columbus, OH (US)

(72) Inventors: Michele Morara, Miami, FL (US); Steven W. Rust, Worthington, OH (US); Mark D. Davis, Sunbury, OH (US); Joseph Regensburger, Grove City, OH (US)

(21) Appl. No.: 14/404,734

(22) PCT Filed: May 29, 2013
(86) PCT No.: PCT/US2013/043061

§ 371 Date: Dec. 1, 2014

Related U.S. Application Data
(60) Provisional application No. 61/652,723, filed on May 29, 2012.

(51) Int. Cl. G06N 5/02; G06N 99/00

(52) U.S. Cl. CPC G06N 5/02; G06N 99/005
USPC 706/12

(57) ABSTRACT

A covariance-clustering algorithm for partitioning a graph into sub-graphs (clusters) using variations of the pseudo-inverse of the Laplacian matrix (A) associated with the graph. The algorithm does not require the number of clusters as an input parameter and, considering the covariance of the Markov field associated with the graph, algorithm finds sub-graphs characterized by a within-cluster covariance larger than an across-clusters covariance. The covariance-clustering algorithm is applied to a semantic graph representing the simulated evidence of multiple events.

### CROSS REFERENCE TO RELATED APPLICATION

The present application claims the benefit of U.S. Provisional Patent Application Ser. No. 61/652,723, filed on May 29, 2012, entitled “Method of Analyzing a Graph with a Covariance-Based Clustering Algorithm Using a Modified Laplacian Pseudo-Inverse Matrix,” the contents of which are hereby incorporated by reference

### BACKGROUND OF THE INVENTION

The present invention pertains to the art of analyzing a knowledge base of narrative text containing information describing evidence for various events in a scenario and organizing the events and information in a format for statistical analysis using mathematical tools which enable an analyst to identify groups or clusters of related information within the knowledge base.

Currently, several nations are facing threats from violent actions taken against them from foreign countries, international terrorists and/or internal organizations that resort to violent actions. In order to counteract or prevent these violent acts, organizations, such as government agencies and in some cases corporations, employ analysts to try to predict when such violent actions will occur.

Generally, the organizations start by collecting information about suspected groups. Such information may be gathered from several sources. For example, computer based communications, such as E-mails, may be intercepted and the contents or summaries of the E-mails stored. Telephone intercepts may be translated and also stored, usually as narrative text. Other information may come from police reports describing the results of searches of people that have been arrested. In some cases, reports may come from military units that capture people or computers having information of interest. In each case, threat analysts usually express scenarios as narrative text using written language. Each entry will generally describe basic information about an event. Specifically, the entry often will include an entity who committed certain acts, what they did, when they did it, where the acts took place, etc. However, the entries and other evidence are often fragmentary and not organized in a meaningful way.

While such information may be useful directly and each narrative report may provide valuable information, often truly useful information needed to predict a violent action may only become apparent when information from various different sources is cross-referenced and analyzed together. Of particular interest is finding a series of events that all relate to each other. The task of figuring out if the events are directed to one or more distinct targets is also desirable, but not easy determinable. Collecting and organizing information from a large number of sources and converting the information into a format that can be easily analyzed has proven to be a difficult task.

U.S. Pat. No. 7,225,122 proposes a method for analyzing computer communications to produce indications and warnings of dangerous behavior. The method includes collecting a computer-generated communication, such as a piece of electronic mail, and parsing the collected communication to identify categories of information that may be indicative of the author's state of mind. When the system identifies an author who represents a threat, then appropriate action may be taken. However, the method only focuses on electronic communications and determining the state of mind of an author. The method does not address any other predictors of when and where a violent event may occur or how multiple communications may be related. Also, the method does not organize the information in a format that may be statistically analyzed by mathematical tools. Instead, the method focuses on using Weintraub algorithms to profile psychological states of an author.

U.S. Patent Application Publication No. 2007/0061758 discloses a method for processing natural language so that text communications may be displayed as diagrammatic representations. This patent document does not address analyzing threat scenarios or even pulling information from different sources and organizing the information.

Algorithms to find partitions of a graph based on a spectrum of a Laplacian matrix date back to the 1970s. Existing methods generally use the eigenvectors associated with the smallest non-zero eigenvalues of the Laplacian matrix of a semantic graph G. The eigenvector v₂ associated with the 2_{nd} smallest eigenvalue λ₂ of the Laplacian matrix associated with a graph is often used to partition a graph into clusters. The eigenvalue λ₂ is called the ‘algebraic connectivity’ of the graph shown in FIG. 6, and the corresponding eigenvector v₂ is called ‘Fiedler vector’. A plot of the sorted components of the Fiedler vector of a graph is produced in FIG. 10. Most of the existing partitioning algorithms use this plot to find clusters. However, no evident clusters can be singled out from this plot. A plot of the sorted components of the Fiedler vector of the transformed Laplacian matrix is shown in FIG. 11. Again, no clusters are distinguishable.

As can be seen from the above discussion, there exists a need in the art for a method providing a structural representation of a scenario that takes narrative text from various sources and produces a format that may be statistically analyzed with mathematical tools and, more particularly, to develop mathematical tools and algorithms that allow analysts to effectively anticipate plausible terrorist attacks given fragmentary evidence (intelligence and other information) stored in knowledge base represented by a semantic graph and to determine which pieces of information are clustered so as to be associated with other pieces of information in a particular cluster.

### SUMMARY OF THE INVENTION

The present invention is directed to a method for finding clusters in a semantic graph representing evidence, described in narrative text communications constituting a knowledge base, showing that certain pieces of information associated with a scenario are clustered and thus probably relate to each other. The method includes collecting narrative text communications, each formed of a group of words. The groups of words in the narrative text communications are organized into the knowledge base as subject-relation-object triples, e.g., Mario Rossi lives at 2932 University Drive”. The items, identified by groups of words, that are either subjects and/or objects of triples as entities, and to the items, identified by groups of words, that are relations of triples are referred to as relations. The triples are represented by a semantic graph, where each node represents an entity and each segment a relation, and the graph is analyzed using mathematical techniques to recognize groupings or clusters of entities. For example, the method preferably determines how closely related entities in a threat scenario, described in narrative text communications and including multiple targets, are to other entities in the threat scenario. Also, the method determines which events and entities are associated with which targets and shows results in a graph to emphasize how many ways each entity is connected to other entities, especially those in the same cluster.

Given the semantic graph, which representing the relations among the entities in a knowledge base, the method generates a symmetric weighted adjacency matrix A as follows: wherever there is a segment (link) between two entities i, j, the adjacency matrix will have a positive entry Aᵢⱼ>0 representing the strength of the relation; where there is no segment (link), the adjacency matrix will have a zero entry. The next step is to generate a diagonal degree matrix D by adding up each value of the entries in each row of the adjacency matrix, and placing the sum in the corresponding diagonal position of the diagonal degree matrix. A Laplacian matrix is then produced by subtracting the adjacency matrix from the diagonal degree matrix. As described by spectral graph analysis, important information about the original semantic graph can be deduced by Laplacian matrix. It is well known that the Laplacian matrix associated with a graph is singular, and so it requires some care in order to be inverted. The next step in the method is to take a pseudo inverse of the Laplacian matrix. The pseudo inverse of the Laplacian matrix is interpreted as a measure of the covariance of the entities in the semantic graph. The next step is to remove all values in the pseudo inverse of the Laplacian matrix that are below a threshold, usually picked as 0. This new matrix constitutes a symmetric matrix, and is interpreted as a new adjacency matrix in the “covariance space”. This new adjacency matrix is again be represented as a graph, and the result is a new graph which takes into account not just direct links between entities, but all the paths that connect pairs of entities in the original graph. If all the nodes of the original graph are connected, then the new graph is complete, since there is always a path connecting each pair of entities in the original graph. The new graph is then projected only onto entities of interest, and possible clusters are highlighted. In the examples shown, the new graph is projected onto three types of nodes: people, references and targets, the resulting graph clearly shows clustering. Another Laplacian matrix may be calculated based on the transformed adjacency matrix, and used to perform spectral clustering of the secondary graph as part of the overall method.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

FIG. 1 is a flow chart showing a covariance-based clustering algorithm using a modified Laplacian pseudo-inverse matrix according to a preferred embodiment of the invention;

FIG. 2 shows an example of semantic graph representing a knowledge base of people, places, objects and actions;

FIG. 3 shows an adjacency matrix generated based on the knowledge base in FIG. 2;

FIG. 4 shows an example of creating a Laplacian matrix by subtracting the adjacency matrix of FIG. 3 from a diagonal degree matrix;

FIG. 5 is a graph showing an adjacency network of a threat scenario knowledge base;

FIG. 6 is a graph showing the pair-wise connectedness of the adjacency network of FIG. 5 to show clustering;

FIG. 7 shows the graph of FIG. 6 projected onto the entities of actors, weapons and locations, with other entities removed to further emphasize clustering;

FIG. 8 is a plot of sorted components of an eigenvector associated with the 3^{rd} smallest eigenvalues of the transformed adjacency matrix that formed the graph of FIG. 5;

FIG. 9 is a plot of the result of a clustering algorithm in accordance with the invention applied to the information in the graph shown in FIG. 5;

FIG. 10 is a plot of the sorted components of the Fiedler vector of the transformed Laplacian matrix of the information in the graph shown in FIG. 5 according to the prior art;

FIG. 11 is a plot of the sorted components of the Fiedler vector of the non-negative transformed Laplacian matrix of the information in the graph FIG. 5 according to the prior art; and

FIG. 12 is a diagram of a system with computers connected to the interne for implementing the clustering algorithm of FIG. 1.

### DETAILED DESCRIPTION OF THE PREFERRED EMBODIMENTS

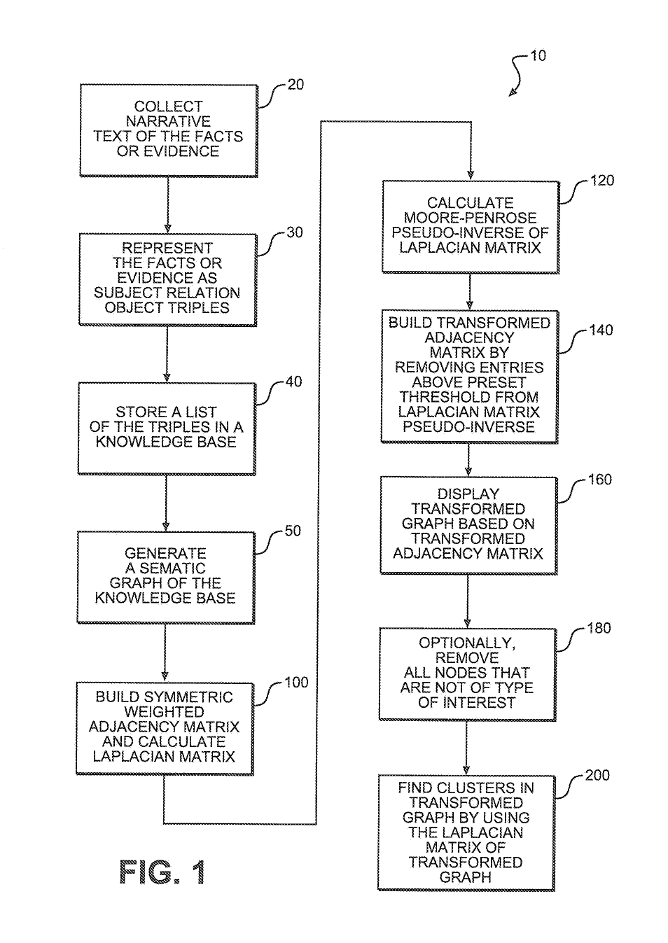

With initial reference to FIG. 1, there is shown a flow chart depicting a method 10 according to a preferred embodiment of the invention. In order to apply mathematical tools to perform quantitative inference, the evidence must first be represented in a simplified organized manner. To achieve this goal, the evidence is collected as a list of subject-relation-object triples into a knowledge base is shown. The items that are either subjects and/or objects are here referred to as “entities”.

A first step 20 in method 10 is to collect narrative text reports containing information about a scenario of interest. As noted above, such text reports may be gathered from several sources. For example, computer based communications, such as E-mails, may be intercepted and the contents or a summary of each E-mail may be stored. Telephone intercepts may be translated and also stored, usually as narrative text. Other information may come from police reports describing the results of searches or data on people that have been arrested. In some cases, reports may come from military units that capture people or computers having information of interest. Regardless of the source in each case, a narrative report is produced.

The evidence, represented as narrative text, is then organized in the knowledge base in the form of a list of triples: “subject-relation-object”. An ontology is developed to specify all the allowable types of triples in the knowledge base, and the narrative text is then organized into triples according to the ontology. The ontology and the list of triples constitute the knowledge base. The items represented as “subject” and/or “attribute” in the triples are referred to as “entities;” and to the items represented as “relation” in the triples as “relations.” At step 30, the information or facts in the groups of words are represented as subject-relation objection triples, e.g., Mario Rossi lives at 2932 University Drive. At step 40, the triples are then aggregated to form the knowledge base.

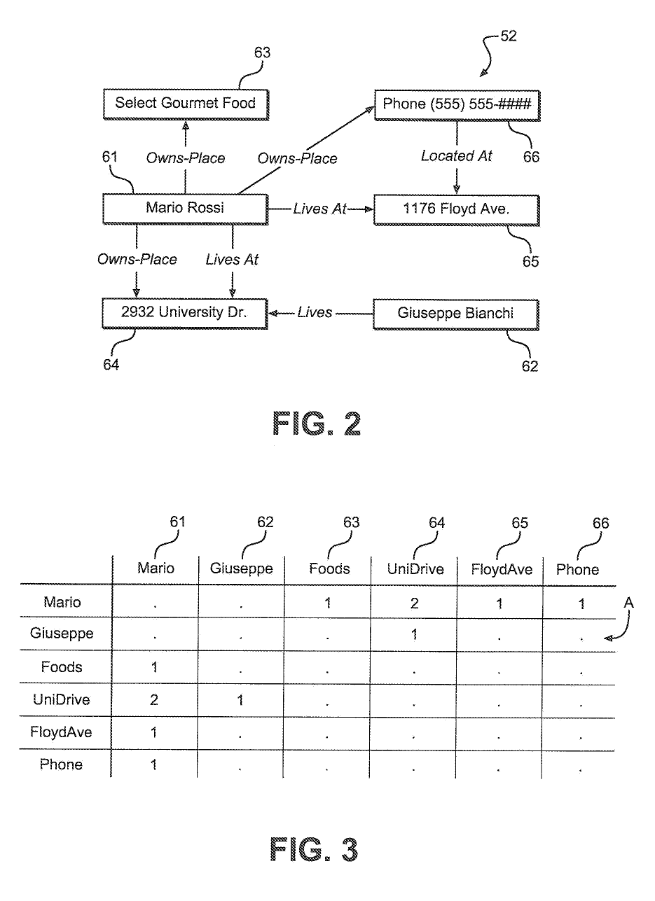

At step 50, the knowledge base is represented by a semantic graph, where each node represents an entity and each segment a relation. An example is shown in FIG. 2 which represents a semantic graph 52 of the knowledge base generated in step 40. Semantic graph 52 shows entities 61-66 arranged to show how entities 61-66 are related to one another. The text has been broken down into simple triples including a subject, a predicate and an object. Essentially, the narrative text is coded into a mathematical format. FIG. 2 includes six entities 61-66 which can either be a subject or an object. In this case, semantic graph 52 shows Mario Rossi 61, Giuseppe Bianchi 62, Select Gourmet Food 63, 2932 University Drive 64, 1176 Floyd Avenue 65 and a phone number 66, i.e., (555) 555-####. Semantic graph 52 shows several triplets of subject, predicate and object. Semantic graph 52 is subject to not only mathematical analysis but is also readable by a human observer. By inspection, one can tell that Mario Rossi 61 owns Select Gourmet Food 63. One can also tell that Mario Rossi 61 owns a phone number 66, i.e., (555) 555-####, located at 2932 University Drive 64 where he lives. Phone number 66 is located at 1176 Floyd Avenue 65 and Giuseppe Bianchi 62 lives at 2932 University Drive 64. Once the narrative has been organized, as shown in FIG. 2, several mathematical operations and analysis are performed on the data. For example, as described in step 100 of FIG. 1, an adjacency matrix is formed, such as adjacency matrix A shown in FIG. 3. In adjacency matrix A, all entities 61-66 shown in FIG. 2 have been placed above the first row and before the first column. Where there is a connection between two entities, a positive number is entered in the appropriate location in adjacency matrix A. In the present example a single connection is shown as a one and multiple connections are shown with higher integer numbers. However, any number greater than zero can be used, depending on the weight given to the relations. No connection is shown as a zero or no entry. For example, there are two connections between Mario 61 and 2932 University Drive 64, thus a “2” is placed in the adjacency matrix at 4,1 and 1,4. Semantic graph 52 shown in FIG. 2 can also be represented as simply six nodes with lines connected between them. An example of such an adjacency graph formed of nodes and lines is shown in FIG. 6, which will be discussed in more detail below. The links between nodes can also be rated, for example, the “2” provided in the adjacency matrix of FIG. 3, between Mario 61 and University Drive 64 indicates double the weight of the connection compared to the connection between Mario 61 and Select Gourmet Food 63.

While FIGS. 2 and 3 show a specific semantic graph 52 and a specific adjacency matrix A respectively, such graphs may be more generally described. For example, a semantic graph G=(V,E) is a weighted graph with nodes {Vᵢ}_{i=1, . . . , N}, edges {Eᵥ}_{v=1, . . . , M}, and weights {Wᵥ}_{v=1, . . . , M}, associated with each edge. Then A ε R^{N×N} would be the weighted symmetric adjacency matrix associated with G calculated at step 100 and defined as:

Aᵢⱼ=Aⱼᵢ=wᵥ, if there exists an edge Eᵥ, with wᵥ≠0, connecting node Vᵢ to node Vⱼ with i≠j;

Aᵢⱼ=Aⱼᵢ=0, otherwise.

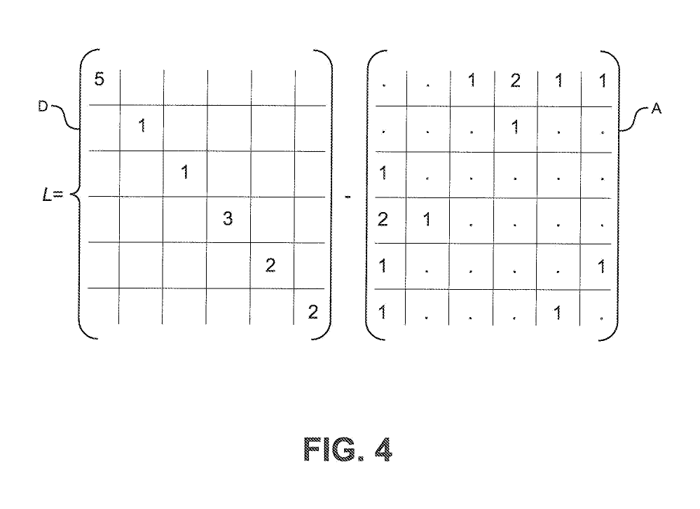

FIG. 4 shows a diagonal degree matrix D formed by adding all the values found in each row of adjacency matrix A and placing the sum of the values in a corresponding row of matrix D along its diagonal. The connection weight values between Mario 61 and Foods 63, University Drive 64 ×2, Floyd Ave 65 and phone number 66 add up to 5, so therefore 5 is placed in the 1,1 position of diagonal degree matrix D and so on. In step 100 of FIG. 1, Laplacian matrix L is simply found by subtracting adjacency matrix A from diagonal degree matrix D.

The next step is to partition a graph into sub-graphs (clusters). In this invention, a cluster S ⊂ G is considered a sub-graph where the nodes are more “connected” to each other than they are to the rest of the nodes in the graph. In statistical data analysis, clusters in the data are characterized by observations having a covariance among each other higher than the covariance with the rest of the data. This statistical interpretation is used to develop the clustering algorithm described in this invention. In particular, a concept of graph-covariance is defined based on the “connectedness” of the nodes in the graph, and then a methodology is provided to partition the graph using the graph-covariance. To achieve this goal in an effective way, the subject method uses variations of a Laplacian matrix and its inverse.

A pseudo-inverse L′ of a Laplacian matrix L is calculated at step 120 and given an interpretation as the covariance-matrix of a random field Z=(Z₁, . . . , Zₙ), defined at each node Vᵢ of graph G. The random field Z is modeled using a conditional autoregressive (CAR) model, with an adjacency structure defined by adjacency matrix A. In a CAR model, the conditional distribution of the field component Zᵢ is defined conditionally to the remaining components {Zᵢ:j≠i} as the weighted average:

$${Z}_{i} = \frac{{\sum }_{j = 1}^{N} {A}_{ij} {Z}_{j}}{{\sum }_{j = 1}^{N} {A}_{ij}} + {ε}_{i}$$

where the error terms are modeled as:

εᵢ˜N(0,Dᵢᵢ⁻¹).

In other words: the value of field Z at node Vᵢ is equal to the weighted average of the values of Z over all nodes Vⱼ connected to Vᵢ, plus an error term that is inverse-proportional to the degree of Vᵢ. It can be verified that the joint normal distribution of Z is:

[Z]∝e−½Z^{T}^{_{LZ}},

which formally yields L=Σ⁻¹, with Σ being the covariance matrix of random field Z. Since L is positive semi-definite with a number of 0 eigenvalues equal to the number of connected sub-graphs of G (including G itself), the Moore-Penrose pseudo-inverse L′ is considered as the covariance-matrix of random field Z.

The connectedness between two nodes in an adjacency graph can also be envisioned by imagining the entire system as a spring mass system where one node may be held stationary and, if the system is excited by moving a second node, the connectedness of that second node to any other node will be the amount that the other node moves given the excitement of the second node. This also relates back to the Moore-Penrose pseudo-inverse L′ because another interpretation of L′ comes from physics or, more precisely, statistical mechanics. Suppose to have a physical system composed of unit-mass particles at each node Vᵢ, and linked to each other by springs of elastic constant kᵥ=wᵥ at each edge Eᵥ. Let Z=(Z₁, . . . ,Zₙ) be the field of the amplitudes of oscillation of the particles in the system. The potential energy of the system can be written as

$$U ( Z ) = \frac{1}{4} {\sum }_{i , j = 1}^{N} {( {Z}_{i} - {Z}_{j} )}^{2} {A}_{ij} = \frac{1}{2} {Z}^{T} ( D - A ) Z$$

and, disregarding the kinetic term, the classical partition function of system is

W=∫e−½Z^{T}^{_{LZ}}dZ.

Therefore, the pseudo inverse of L is interpreted as the covariance-matrix of the amplitudes of oscillation of the particles of a spring-network defined by weighted adjacency matrix A.

At step 140, the clustering algorithm of the current invention starts by representing the elements of the pseudo-inverse L′ of the Laplacian which are above or equal a given threshold usually set equal to zero, as the adjacency matrix of a new graph, which is displayed at step 160. Preferably all nodes that are not of the type of interest are removed at step 180. The algorithm then tries to find clusters into this new graph at step 200 as described more fully below. Without loss of generality, suppose G to be a connected graph. If a graph G contains non-connected sub-graphs, then the clustering algorithm should be applied to each connected sub-graph. Notice the partition of a graph into connected sub-graphs can be solved in linear time using either ‘breadth-first search’ or ‘depth-first search’. The covariance clustering algorithm comprises the following steps:
1) Given a undirected connected graph G, build the weighted adjacency matrix A, the Laplacian matrix L, and calculate the pseudo-inverse L′;
2) Construct a “transformed” adjacency matrix Âᵢⱼ(η)=max(L′ᵢⱼ,η), where η is a real number referred to as ‘threshold’;
3) Partition at step 200 graph G based on “transformed” graph Ĝ(η) associated with adjacency matrix Âᵢⱼ(η) using the transformed Laplacian \hat{L}=\hat{D}−Â, where \hat{D} is the degree matrix defined as: \hat{D}ᵢᵢ=Σⱼ₌₁^{N}Âᵢⱼ; \hat{D}ᵢⱼ=0 for every i≠j.

A good choice for threshold η is the average of the elements of L′, that is,

$${η}_{0} = \frac{1}{{n}^{2}} {\sum }_{i , j} {L}_{ij}^{′} .$$

Considering that, in a connected graph, the constant eigenvector u=(1,1, . . . , 1) is associated with the 0 eigenvalue, then

$${\sum }_{i , j} {L}_{ij}^{′} = {\sum }_{i} {( {L}^{′} u )}_{i} = 0$$

and therefore η₀=0.

Another feature of the invention is the possibility to “prune”, for example, at step 180, the new graph in order to keep only the entities that are of interest in the analysis. Consider, for example, a graph G=(V, E) containing only two types of nodes: ‘Person’ and ‘City’. Suppose that nodes of type ‘Person’ are connected only to nodes of type ‘City’. Moreover, suppose that analysts are interested only in clustering nodes of type ‘Person’. If the sub-graph G₁ ⊂ G containing only ‘Person’-type nodes is considered, then G₁ will have no edges (each node is disconnected) and therefore the sub-graph G₁ will provide no information about the relationships among the ‘Person’-type nodes in the graph. However, if the matrix Â is built from the pseudo inverse of the Laplacian, and the graph Ĝ associated with Â is considered in the covariance-space, each node of type ‘Person’ will be connected to every other nodes of type ‘Person’ through paths in the original graph G. The sub-graph G₁ ⊂Ĝ containing only ‘Person’-type nodes is used to find clusters of persons using the spectrum of A₁, which is the sub-matrix of Â containing only rows and columns associated with ‘Person’-type nodes. Â₁ is called the projection of Â onto the ‘Person’-type nodes. Projecting A onto the nodes-of-interest can improve the classification power of the clustering algorithm, as the following example shows.

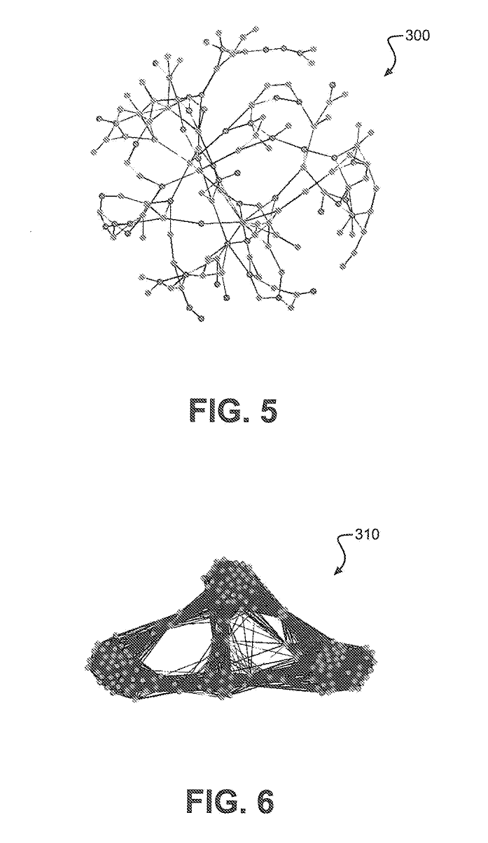

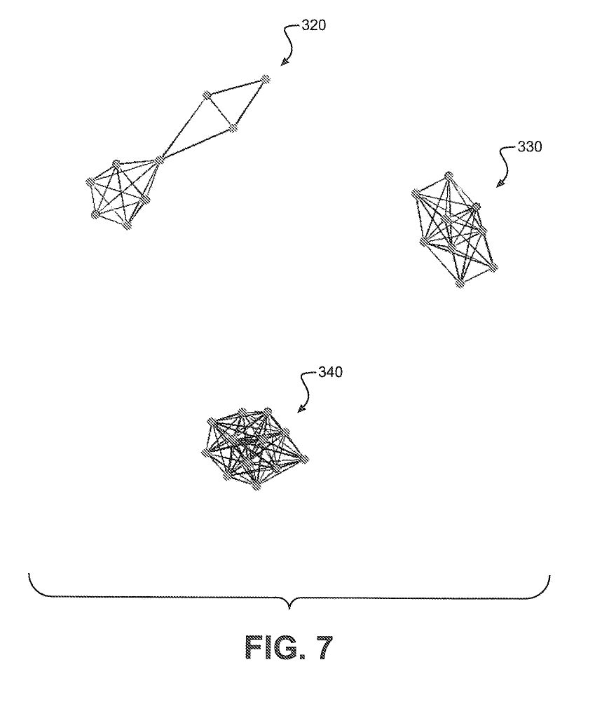

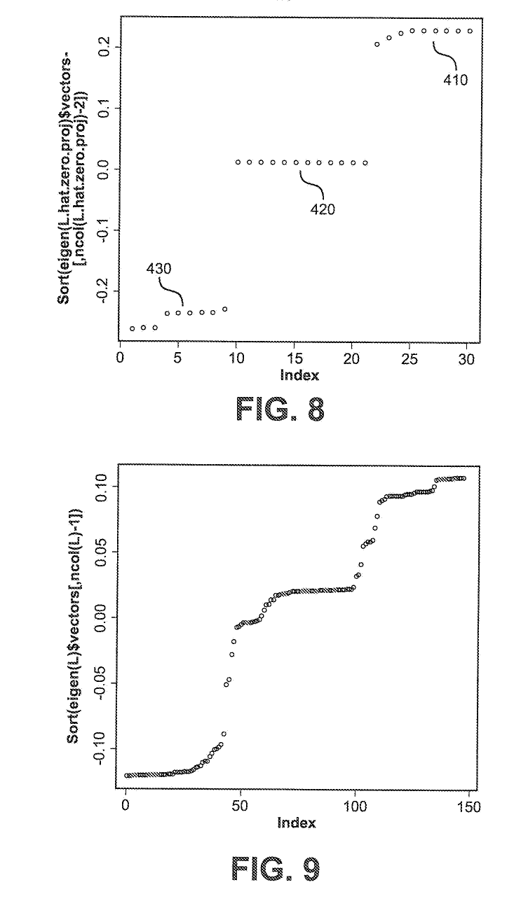

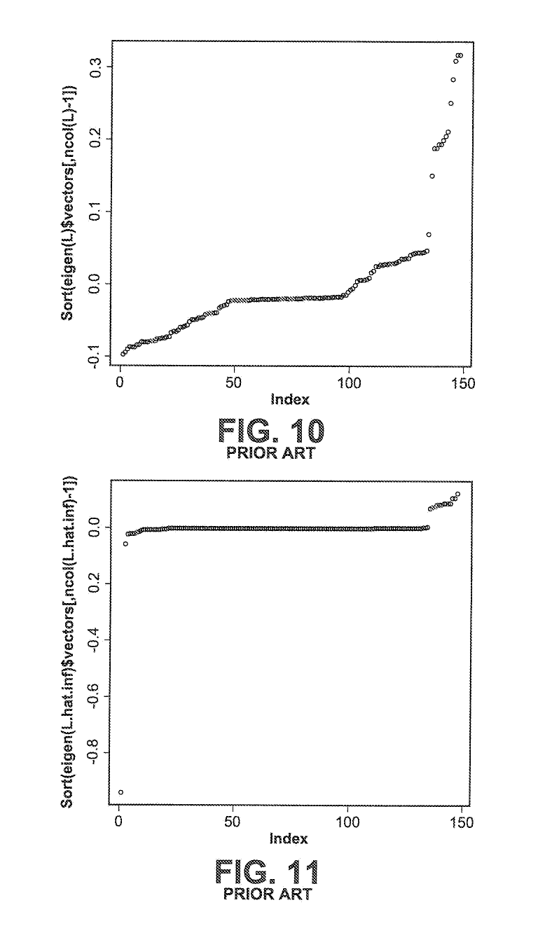

FIG. 5 represents an adjacency graph; in this case, a knowledge base was built using a Sign of the Crescent case-study given at the Joint Military Intelligence College, Defense Intelligence Agency. A plot 300 of the adjacency graph using the force-directed layout algorithm of the Social Network Analysis by Carter Butts, SNA R-package is shown in FIG. 5 and clusters are not distinguishable. As described above, each node represents an entity and the segment between each node represents the fact that the nodes are connected somehow. In general, the goal of the analysis is to find out how many different ways each node is connected to any other given node. Essentially, the number of connections between one node and another node must be counted. Two nodes that are highly connected have numerous possible ways of traveling between them, while two nodes that are connected would have fewer such paths. The connectedness between two nodes can also be envisioned by imagining the entire system as a spring mass system where one node may be held stationary and, if the system is excited by moving a second node, the connectedness to that second node given any other node will be the amount that the other node moves given the excitement of the second node. A plot 310 of the graph Ĝ(0), associated with the transformed adjacency matrix Â with a threshold η=0, using the force-directed layout algorithm of the SNA R-package is shown in FIG. 6 showing the formation of clusters with a simple visual analysis. Since the interest is in finding the terrorist attacks, Â is projected onto nodes of type: people, weapons, targets. A plot of the corresponding projected graph Ĝᵢ is shown in FIG. 7, the nodes representing the entities (persons, weapons, targets) involved in the three different attacks. The covariance-clustering algorithm, together with a typed-projection, completely classified the entities that took part in the three different attacks 320, 330, 340. The clusters in Ĝ₁ are identified by using the eigenvectors of Â₁ associated with the smallest non-zero eigenvalues. A plot of the sorted components of the eigenvector associated with the 3^{rd} smallest eigenvalue of Â₁ is shown in FIG. 8 and clearly indicates the presence of three clusters. Finally, a plot of the sorted components of the Fiedler vector of the non-negative transformed Laplacian matrix \hat{L} is shown in FIG. 10. Three clusters associated with the three terrorist attacks are shown separated by the two large gaps around index=50 and index=100. The last plot is the result of the clustering algorithm described in this invention with the suggested threshold η=0.

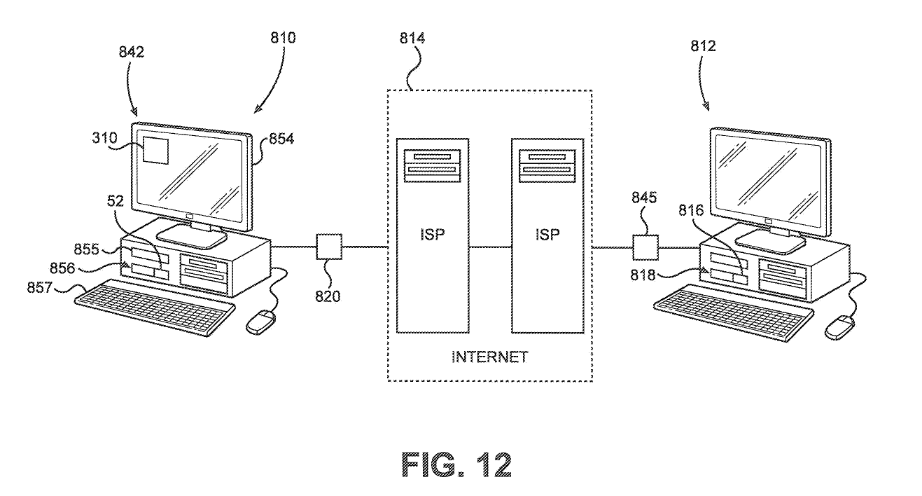

As shown in FIG. 12, a system for implementing the method shown in FIG. 1 in accordance with a preferred embodiment of the present invention includes an analyst's computer system 810 which can be connected to one or more other computer systems 812 over an electronic communications link such as the internet 814. As illustrated in FIG. 12, analyst's computer system 810 includes an input-output unit 820 for transmitting and receiving digital information to or from the internet 814. Likewise, each computer system 812 is also set up to contact internet 814 through an input-output unit 845 and preferably hosts websites 816 in a memory 818. Computer 810 typically has a monitor 854, a central processing unit 855, some type of memory 856 and a keyboard 857. Typically, when in use, analyst's computer operating system, such as Macintosh®, Unix® or Windows® which controls the basic operations of the computing machine. Additionally, specialized applications, such as a web browser, would be used to interpret the various protocols of internet 814 into an understandable interface for a computer user, namely the analyst. The knowledge base is preferably stored in memory 856 as semantic graph 52 or in other formats. Plot 310 of graph Ĝ(0) or other graphs developed with the clustering method are preferably displayed on monitor 854. Various specific pieces of software used to complete the method steps of algorithm 10 shown in FIG. 1 reside in memory 856. For example the force-directed layout algorithm of the Social Network Analysis by Carter Butts, SNA R-package is preferably located in memory 856.

Based on the above, it should be readily apparent the method of the present invention provides an efficient way to identify clusters in a knowledge base. The “transformed” graph Ĝ can be viewed as a covariance representation of the original graph G. In G the relationships among the nodes are induced by the paths in the original graph G. Moreover, since G is usually dense (in fact, G is complete whenever G is connected), Ĝ can be projected onto subsets of nodes of type of interest (e.g., persons, weapons, and targets, in the example given above), and improve the discrimination power of the algorithm.

Although described with reference to preferred embodiments of the invention, it should be readily understood that various changes and/or modifications can be made to the invention without departing from the spirit thereof. For example, The covariance clustering algorithm may be applied to any adjacency graph, not just one created from a threat scenario, regardless of what data is used to create the graph. For example, the algorithm can be used to analyze the World Wide Web, using a graph where each node is a web page and each segment is a link between pages. In general, the invention is only intended to be limited by the scope of the following claims.

1. A computer implemented method for analyzing a graph, representing messages including groups of words that describe facts about entities, with a covariance-base clustering algorithm for determining how closely related the entities are to each other, the method comprising:
collecting the messages;
storing the facts into a knowledge base;
representing the knowledge base as a semantic graph;
building a weighted, symmetric, adjacency matrix from the semantic graph;
calculating a Laplacian matrix from the adjacency matrix;
calculating a Moore-Penrose pseudo-inverse of the Laplacian matrix;
building a transformed adjacency matrix equal to the pseudo-inverse of the Laplacian matrix with all entries, which are greater than or equal to a chosen threshold; and
performing a spectral analysis on the transformed adjacency matrix to identify clustering in the semantic graph.

2. The method according to claim 1, further comprising displaying the transformed adjacency matrix as a transformed graph on a display screen and showing how closely related the entities are to each other.

3. The method according to claim 2, wherein performing the spectral analysis includes determining which entities are clustered together on the transformed graph by separating sub-graphs characterized by a within-cluster covariance larger than an across-clusters covariance.

4. The method according to claim 1, wherein storing the facts into a knowledge base includes creating a list of subject-relation-object triples, wherein each of the groups of words used as a subject or an object in each triple constitutes one of the entities and every group of words used as a relation in a triple defines a relationship between the subject and object.

5. The method according to claim 4, wherein representing the knowledge base as a semantic graph includes creating said semantic graph with nodes and edges, while representing one of the entities with each node and representing a relationship between two of the entities with each edge.

6. The method according to claim 5, wherein building a weighted, symmetric, adjacency matrix includes associating a weight to each edge in the graph representing a strength of a relationship between each pair of entities.

7. The method according to claim 1, further comprising setting the chosen threshold equal to an average of the entries of the pseudo-inverse of the Laplacian matrix.

8. The method according to claim 1, wherein collecting the messages includes collecting computer based communications and producing a narrative report.

9. The method according to claim 8 wherein producing a narrative report includes summarizing emails.

10. The method according to claim 8, wherein the communications are webpages.

11. The method according to claim 1, wherein collecting the messages includes summarizing conversations in a text format.

12. The method according to claim 1, wherein the messages describe a threat scenario.

13. A method for determining how closely related entities in a threat scenario, described in narrative text communications and including multiple targets, are to other entities in the threat scenario and for determining which entities are associated with which targets, the method comprising:
collecting narrative text communications, including facts or evidence, each communication including a group of words, regarding the threat scenario;
storing the facts into a knowledge base as a list of subject-relation-object triples with the subject or object of each triple representing one of the entities, and
representing the knowledge base as a semantic graph, with nodes representing the entities and edges representing the relations;
building an adjacency matrix;
calculating a Laplacian matrix from the adjacency matrix;
building a transformed adjacency matrix equal to a pseudo-inverse of the Laplacian matrix; and
performing a spectral analysis on the transformed adjacency matrix to identify clustering in the semantic graph.

14. The method according to claim 13, wherein building an adjacency matrix comprises building a weighted, symmetric, adjacency matrix associating a weight to each edge in the graph measuring a strength of the relation between each pair of entities.

15. The method according to claim 14 further comprising:
calculating a Moore-Penrose pseudo-inverse of the Laplacian matrix prior to building the transformed adjacency matrix;
building the transformed adjacency matrix with all entries in the adjacency matrix that are greater than or equal to a chosen threshold set equal to zero
setting the threshold equal to an average of the entries of the pseudo-inverse of the Laplacian matrix;
displaying a transformed graph associated with the transformed adjacency matrix; and
calculating a transformed Laplacian associated with the transformed adjacency matrix.

16. The method according to claim 1 further comprising projecting the transformed adjacency matrix onto a subset of entities of interests.

17. The method according to claim 15 further comprising projecting the transformed adjacency matrix onto a subset of entities of interests.
